(19) United States
(12) Patent Application Publication
(10) Pub. No.: US 2014/0183963 A1
(43) Pub. Date: Jul. 3, 2014

(54) Power Transmission in Drilling and related Operations using structural members as the Transmission Line

(71) Applicants: Kenneth B. Wilson, Houston, TX (US); Joseph E. Comparetto, Wylie, TX (US)

(72) Inventors: Kenneth B. Wilson, Houston, TX (US); Joseph E. Comparetto, Wylie, TX (US)

(21) Appl. No.: 13/729,621

(22) Filed: Dec. 28, 2012

(51) Int. Cl. H01F 38/14

(52) U.S. Cl. CPC H01F 38/14
USPC 307/104

(57) ABSTRACT

A generating system or transmission system for imparting and transmitting electrical power onto a continuous long electrical conductor for use related to drilling and fluid piping operations. The transmission system may include a power generator/transmitter, voltage transformers, a movable transmission line including the rotational (tubing, piping, casing, liner hanger, drill string, etc.) a receiving circuit/receiver that may be tuned for impedance matching and a converting device to output the transmitted power at a predetermined voltage to be either used immediately by a power consuming device or to be stored in a energy harvesting array such as but not limited to batteries.

### FIELD OF THE INVENTION

The present invention relates to transmission systems and more particularly to a transmission system having a transmission line which is rotatable and longitudinally movable.

### BACKGROUND

In industries where fluids are piped over what is (currently) considered long distances such as from a few hundred yards to a few miles, particularly from subterranean locations, electrical power is considered a valuable commodity. Power is necessary for operations such as opening and closing valves to control flow, pumping fluids and sending and receiving telemetry data for monitoring operations. A variety of other applications may require power for necessary operational conditions.

Traditionally, power is transmitted via the use of an independent transmission line (an additional cable line usually made of copper and electrically insulated) to the movable/rotatable transmission line. The problem with this method is that it is very difficult to have power available during many applications while motion, particularly rotation is required. For example: during drilling operations, an additional cable delivering power to the drill bit for monitoring applications or logging would be quite complicated in the sense that it would most likely get tangled up around the drill string due to the high torque provided by the motor.

As drilling operations advance farther with longer distances due to improved material properties in drilling components and increased drilling power requirements, the need for power at an intermediate position along the drill string for monitoring, vibration control, communication for directional bits and numerous other applications is increasing.

### SUMMARY

A transmission system for transmitting a power signal may include a power generator to generate the power signal to the transmitted, an AC to AC converter to convert a frequency of the power signal, a transmitter to transmit the power signal including a transformer to convert the voltage of the power signal and a transmit coil to transmit the power signal, a transmission line to receive the power signal from the transmit coil, a receiver to receive the power signal from the transmission line.

The transmission line may be rotatable and movable in the longitudinal direction of the transmission line.

The receiver may include a receive coil to receive the power signal from the transmission line.

The transmission line may be a pipe.

The transmission line may be a well bore pipe.

The receiver may include a transformer.

The receiver may include a AC/AC converter.

The receiver may include a AC/DC converter.

The power signal may be in the range from a fraction of a milliwatt to multiple kilowatts.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates the transmission system of the present invention;

FIG. 2 illustrates the Insertion Loss which may be measured of the present invention;

FIG. 3 illustrates the Insertion Loss for at 4 power levels of the present invention;

FIG. 4 illustrates a Comparison of Power to Voltage;

FIG. 5 illustrates the Voltage (VP-P) transmitted by the transmitter;

FIG. 6 illustrates Voltage (VP-P) transmitted and received by the present invention;

FIG. 7 illustrates the Measured Voltage (VP-P), Impedance (K-Ohms), and Power Transferred (mW);

FIG. 8 illustrates a circuit diagram of the present invention.

### DETAILED DESCRIPTION

The present invention includes a transmission system 100 to propagate a power signal having Very Low Frequency (VLF) electromagnetic waves along a well-bore pipe 101 and being much less lossy (more efficient) than the propagation of a signal in free space. The efficiency is largely achieved due to the difference between radiating in three dimensions (i.e. free space) vs radiating in two dimensions (i.e. coaxial cable or well-bore pipe 101). The power level of the power signal may be observed (measured) or harvested at any point (destination) away from the source of the power signal.

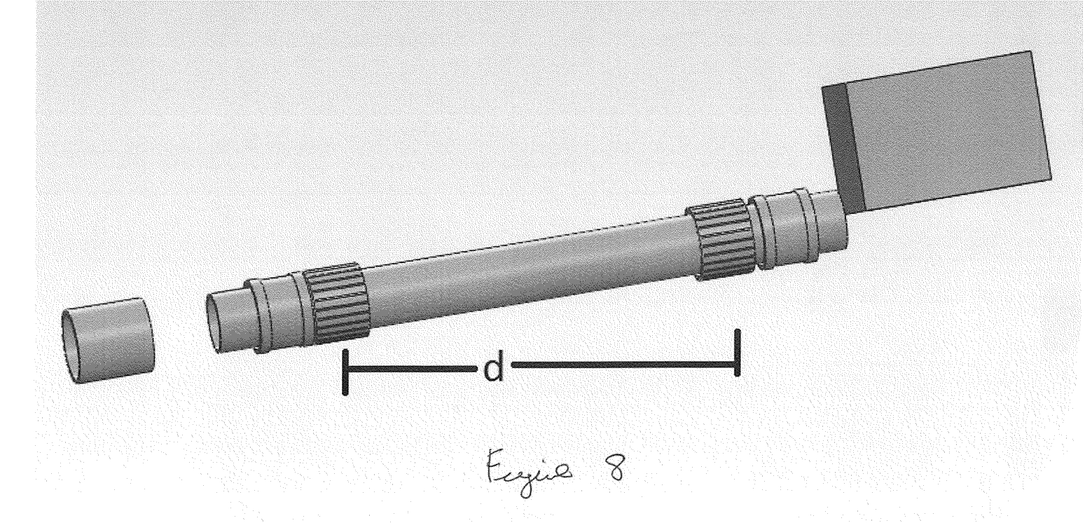

FIG. 8 illustrates the transmission system 100 of the present invention which may include an electrical power generator 2 which may generate electrical power as the initial power source. The electrical generator 2 may generate DC or AC power and frequency may be a factor in the power transmission. Although any power source may be used in theory, a 60 Hz power source may be employed because of the commercial availability of such generators.

A transmitter 103 may include a transformer 4 which may be a hollow cylinder positioned as a sleeve on the transmission line 5 to transfer the electrical power from the generator 2. The generator 2, which may be a 60 Hz, may include an AC to AC adapter 133 to change the frequency from the generator 2 to the appropriate pre-determined frequency which may be dependent on a multitude of factors including the transmission distance. This frequency may vary from 10 kilohertz for transmissions of a few miles to above 1 MHz for transmissions of a few hundred feet. The transmitter 103 may include an impedance matching circuit 3 which may be a hollow cylinder positioned as a sleeve on the transmission line 5 and which may be housed in a protective rigid casing to match the impedance of the power generator 2. The voltage to be transmitted may then need to be stepped up by the transformer 4 for reasons of efficiency since power losses are proportional to I²R and lowering the current greatly increases the efficiency. The transformer 4 may be chosen as appropriate for the radial geometry of the transmission line 5.

The transmission line 5 which may be a hollow cylinder may be the drillstring, well lined pipe 101 or pipe. The transmission line 5 may be hollow or solid and may be formed from metal such as steel or other type of appropriate material. The specific type of metal or steel may vary in composition depending on the type of application, location, climate and many other factors. It may be more efficient to use a ferromagnetic metal. However, often times it stainless steel used to form the transmission line 5. Stainless steel may be preferential in regards to permanent aspects of the installation of the system. Stainless steel may be used to mitigate the long term effect of corrosion due to minerals in the ground.

The transmission line 5 may include an outer coating of film to reduce the corrosion which may result from the transmission of high voltage on ice the transmission line 5. Since corrosion is dependent on both the fluidic environment and the specific composition of the transmission line 5 (drill string, linear, casing, etc), it may be difficult to say corrosion would be a problem for all cases or to rule it out entirely as a problem for specific cases. Corrosion may be a slow process that would only become an issue after a long time (on the order of a year(s)). No additional significant problems may be foreseen because increased electrochemical activity and may only occur if the transmission line 5 is charged relative to some other surface. Since there is no separate ground to the transmission line 5, the transmission line 5 may not be charged relative to some other surface for increased corrosion to occur.

The receiver 103 may include a transformer 6 which may be a hollow cylinder and position as a sleeve on the transmission line 5, and receiver 103 may be positioned near the location of the power reception point. The transformer 6 may step down the voltage. The receiver 103 may impedance match the power transmitted in the transmission line 5 by a impedance matching circuit 107 which may be a hollow cylinder and positioned as a sleeve on the transmission line 5. The receiver 103 may include an AC to AC converter (or possibly an AC to DC converter 147 which may be a hollow cylinder positioned as a sleeve on the transmission line 5 if the desired power output is DC) so that the frequency matches the necessary frequency for power to drive whatever piece of equipment is desired (this will most likely be 60 Hz or DC since most conventional equipment operates on 60 Hz or DC voltages)

A voltage regulator 141 may be a hollow cylinder and positioned as a sleeve on the transmission line 5 to regulate the output voltage signal from the transformer 4 and the receiver 105 may ensure that the tool 8 which may be a hollow cylinder and positioned as a sleeve on the transmission line 5 which may be connected to the receiver 105 (turning on a pump, drill, open/close a valve, send/receive data and telemetry etc.) does not overload.

The receiver 105 may include an energy harvesting array 143 which may be a hollow cylinder positioned as a sleeve on the transmission line 5 to store or recharge energy and may be a rechargeable battery pack or any other appropriate device. This harvesting by the energy harvesting array 143 may be charged while the tool 8 may not be operating and then discharge power to power the tool 8 by a switch which may be controlled by an operator. The transmission line 5 may rotate clockwise or counterclockwise and may move in the longitudinal direction of the transmission line 5.

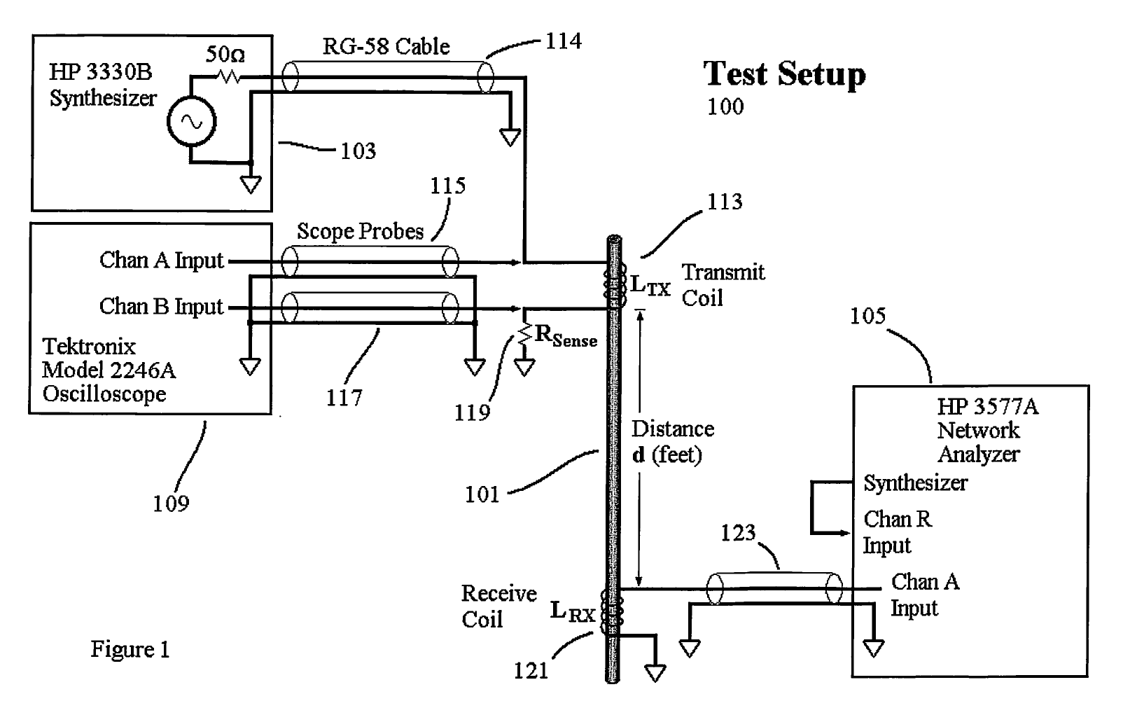

The power generator 2 may be any size generator including a small commercially available Honda generator or an industrial strength 3 phase generator based on the desired amount of power transmitted on the transmission line 5. The power generator 2 may be connected to an impedance matching circuit 3 which may be a cylinder to be positioned as a sleeve on the transmission line 5. The length of the transmission line 5 may be known or unknown, but the impedance matching circuit 3 may be designed to transmit the power over the known distance. Based on this known distance of the transmission line 5, an appropriate frequency may be selected to convert the generated power frequency (usually 50-60 Hz) to the appropriate transmission frequency (which may be dependent on transmission distance) using an AC-AC converter 147 or equivalent circuit. The converter circuit 147 may be connected to a transformer 4. The transformer 4 may step the voltage up and the current down (or vice versa) in order to keep the power losses along the transmission line minimal. Ultimately, the final transmitting coil 113 (which is part of the transformer as shown in FIG. 1) may be wrapped around the transmission line 5 (in the same manner as a solenoid and any coil configuration is possible). The AC power transmitted to the transmission line 5 (in the manner in which a solenoid imparts its field to a (usually) iron core). The power is then transmitted down the transmission line 5. For most industrial applications (mining, drilling, oil and gas, fluid transmission, pipeline etc.), the transmission line 5 may be formed from steel or other appropriate material, but steel may be the most practical selection for two reasons: 1, cost and availability and 2, desirable electromagnetic properties. Most standard physical phenomenon may occur during the transmission in the transmission line 5 (such as power losses, telegrapher equation (second order effects in time), skin effect, standing waves, etc.) which are all tuned to have minimal effect in the transmitting and receiving impedance matching circuits 3 7. When the power reaches its destination point “Power Reception, Location B” 009/receiver 105, the reverse steps are now taken from the procedure at Location A. The power signal is first received into a transformer 6 which may be a cylinder positioned as a sleeve to the transmission line 5, which performs the opposite function of transformer 4 stepping the voltage down and the current up (or vice versa). The power signal may be received an impedance matching circuit 7 which may be a cylinder position as a sleeve to the transmission line 5 and which may include another AC-AC converter 149. This circuit 7 may be tuned to allow the power to be transmitted with minimal power loss. The circuit 7 and converter 149 may now allow for the power to be received by a tool 8 or energy storage device (such as a battery pack) for which power is needed. The design of the impedance matching circuit, AC-AC converters, transformer, and coil selection may vary because they are all heavily dependent on the transmission distance which varies greatly from just a few hundred feet (−1 Mega Hz) to a mile or two (100 kilo Hz).

The method of measuring the change in the power level of the power signal may be based on comparing the power level of the power signal being transmitted at the transmitter to the power level of the power signal received at the destination. This power ratio may be called “Insertion Loss.” Measurements to determine the power ratio or insertion loss may be simultaneous gathered at the source (transmitting end) by a transmitter 103, and at the destination (receiving end) by a receiver 105, and then the power ratio may be calculated based on these measurements and known quantities. When referring to measurements of power, a ratio may be expressed in decibels by evaluating ten times the base-10 logarithm of the ratio of the measured quantity to a reference level. Thus, the ratio of a power value P(OUT) which may be from the transmitter 103 to another power value P(IN) which may be from the receiver 105, may be expressed in decibels, and may be calculated using the formula:

$$POWER {RATIO}_{dB} = 10 {log}_{10} ( \frac{Pout}{Pin} )$$

Equation 1: Equation for Power Ratio and in this application referred to as “Insertion Loss.”

The measurement of voltage amplitude is another factor to be considered. When referring to measurements of voltage amplitude, it is usual to consider the ratio of the squares of Vout (measured amplitude) from the transmitter 103 and Vin (reference amplitude) from the receiver 105. This is because, in most applications, power is proportional to the square of voltage amplitude, and it is desirable for the two decibel formulations to give the same result in such typical cases. Thus the following definition is used:

$$VOLTAGE {RATIO}_{dB} = 20 {log}_{10} ( \frac{Vout}{Vin} )$$

### Equation 2: Equation for Voltage Ratio.

In this application, both power and voltage may be considered because both are relevant.

The apparatus for the transmission system 100 may include standard instrumentation with as few custom components as possible. A precision sinusoidal synthesizer (Hewlett Packard model HP 3330B) may be the transmitter 103 used to produce the transmitted power. A helpful feature of this instrument was to produce sinusoids at a predetermined power level in units of dBm. The received power may be received by receiver 105 and may be measured using a network analyzer 107 (Hewlett Packard model HP 3577A). This instrument which may be the network analyzer 107 may gather its native measurements in units of dBm. Thus, both the transmitted power and received power may be in the same units. The transmission system 100 shown below in FIG. 1 also include an oscilloscope 109 (Tektronix model 2246A) so that Peak-to-Peak Voltage (VP-P) measurements could be made.

FIG. 1 illustrates the transmission system 100 which may include a transmitter 103 and a well bore pipe 101 and illustrates that the transmitter 103 may be connected to the well bore pipe 101 by a first transmit cable 111. The well bore pipe 101 may include a transmit coil 113 which may have an inductance L_{TX} and which may coil around the exterior surface of the wellbore pipe 101 and may be connected to the first transmit cable 111 which may also be connected to ground. The transmitter 103 may be a synthesizer as described above.

The transmission system 100 may include an oscilloscope 109 which may include a first scope probe 115 which may be connected to a first end of the transmit coil 113 and a second scope probe 117 which may be connected to a second end of the transmit coil 113. The first scope probe 115 and the second scope probe 117 may be connected to ground, and the second scope probe 117 may be connected to a sense resistor 119 which may have a sense resistance R_{SENSE} and which may be connected to ground.

A receive coil 121 may coil around an opposing end of the well bore pipe 101 and which may be connected to a second receive cable 123 which may connect to the receiver 105 which may be the network analyzer as described above and which may be connected to ground. An opposing end of the receive coil 121 may be connected to ground and the inductance of the receive coil 121 may be L_{RX}.

Measurement data may be obtained at both ends of a 99 foot long, 2⅞ inch diameter well-bore pipe 101. Other wellbore pipes may be used with the transmission system 100 of the present invention. At the end (source) of the transmitter 103, a Hewlett Packard model HP3330B synthesizer may be connected to the transmit coil (L_{TX}) 113 and a sense resistor (R_{SENSE}) 119 may be used to generate the electromagnetic power wave. At the other end of the well-bore pipe 101 (destination) was a receive coil (L_{RX}) 121 may be connected to a Hewlett Packard model HP3577A network analyzer (receiver 105).

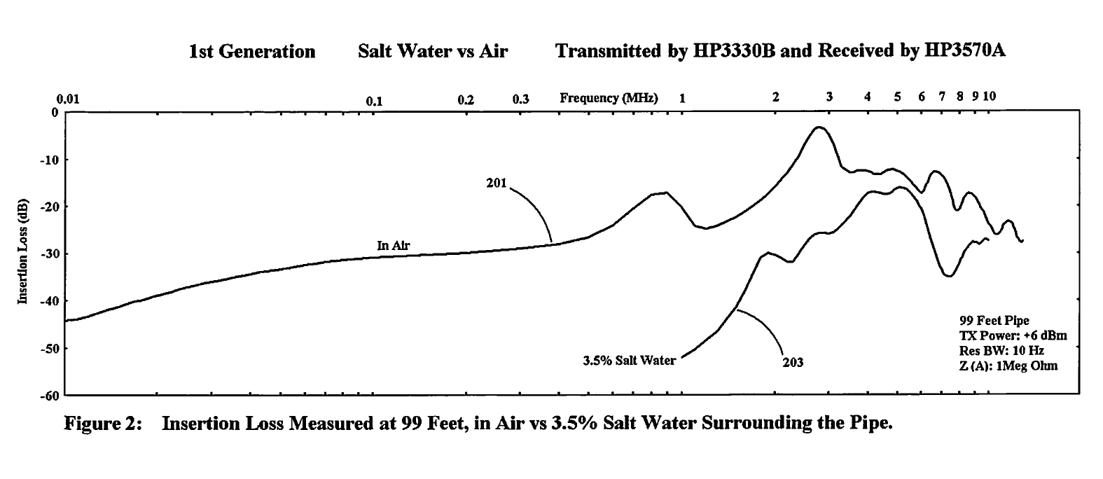

Since only a portion of the power generated by the HP3330B synthesizer actually gets to the transmit coil (L_{TX}) 113, both indicated (by the instrument) and actual transmit power were recorded. Actual Voltage across the transmit coil 113 as well as receive coil 121 was measured using the differential mode (Chan A−Chan B) of the Tektronix model 2246A oscilloscope 109. Indicated transmit power may be recorded from the front panel of the HP 3330B synthesizer (the transmitter 103). Power received may be measured using the HP3577A network analyzer (the receiver 105), which natively compares received power (Chan A) to its reference power (Chan R) and then calculates the ratio using equation 1. In the graph in FIG. 2, the ratio of power transmitted to power received may be referred to as “Insertion Loss” and maybe plotted against frequency. One curve 201 shows insertion loss in air and the second curve 203 shows insertion loss in substantially 3.5% salt water.

FIG. 2 illustrates by example the Insertion Loss which may be measured at 99 feet, in air and substantially 3.5% salt water surrounding the wellbore pipe 101.

Of interest is the −3 dB peak at substantially 2.8 MHz, indicating that approximately half the power is lost. This frequency corresponds to the quarter wavelength of 99 feet of the wellbore 101.

### Scalability of Power Level

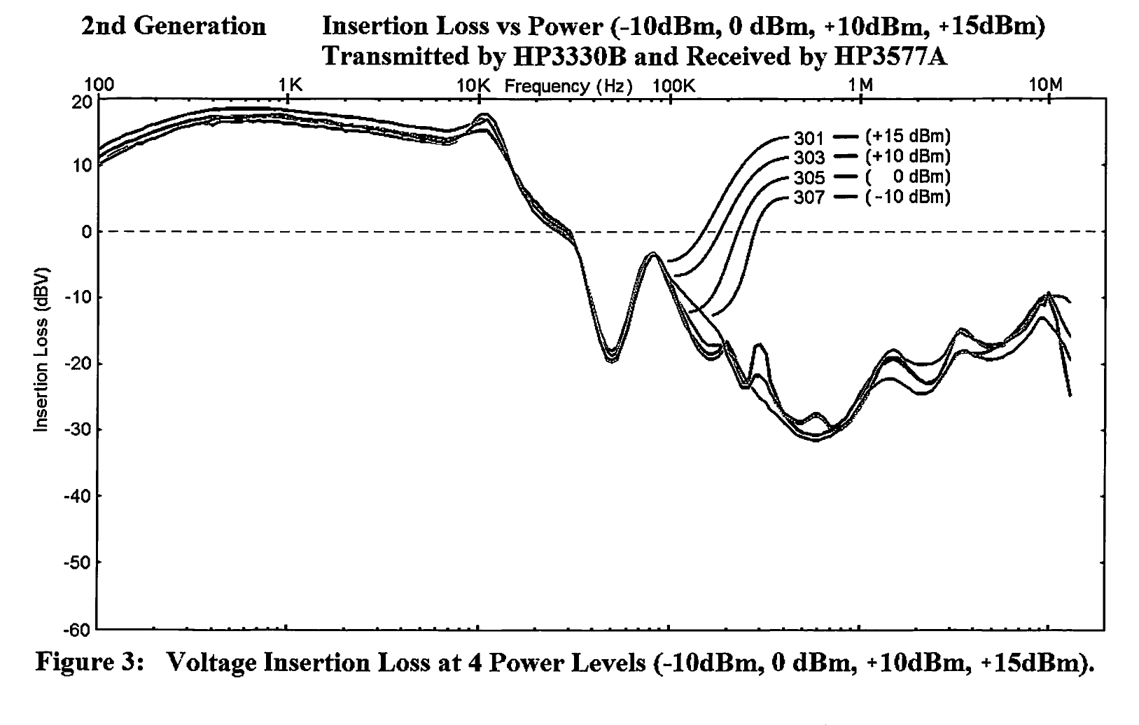

Transmission of power over long distances of well-bore pipe 101 may depend on several factors. The transmitter power of the transmitter 103 may be high enough to overcome the insertion loss, and may be near or at the correct frequency corresponding to the length of the pipe. Other factors may also apply to the transmission of power (i.e. impedance matching). The additional consideration in the transmission of power through the wellbore pipe 101 is scalability. Scalability may refer to increasing the transmitted power in order to achieve a corresponding increase in received power. Measurement data may be gathered at several transmit power levels (−10 dBm, 0 dBm, +10 dBm, and +15 dBm—a range of more than 200:1) to determine if the power level scaled linearly. The graph in FIG. 3 plots the ratio of power received over power transmitted (Insertion Loss using Eqn. 1) for different power levels vs frequency.

FIG. 3 illustrates the Insertion Loss for at 4 power levels (−10 dBm, 0 dBm, +10 dBm, +15 dBm). Other power levels are within the scope of the invention.

These curves 301, 303, 305, 307 shown in FIG. 3 indicate no major difference in insertion loss as the power level is increased more than 200 times. Thus the ratio of received power to transmitted power (insertion loss) scales substantially linearly with power level. The implication here is that if more received power is needed by the receiver 105, then the transmitter 103 may transmit more power to the receiver 105.

### Comparison of Power to Voltage

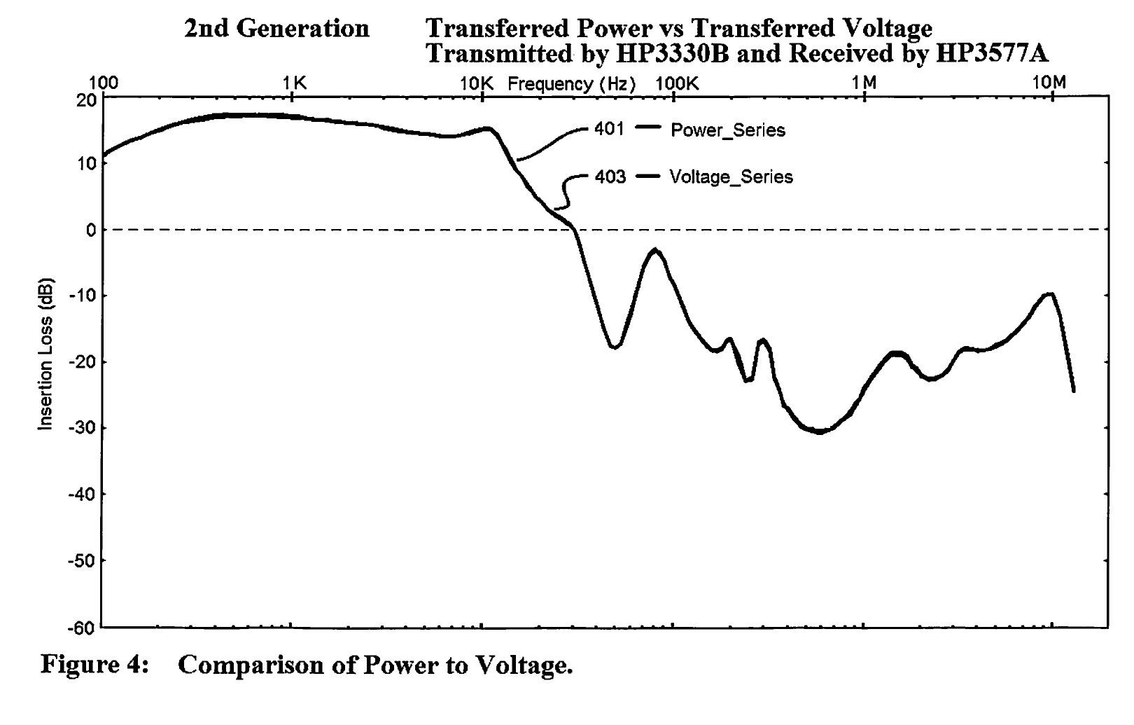

In this application, electromagnetic power may be measured, as well as the voltage. The voltage may relate to the specific method of harvesting the received electromagnetic power at the receiver 105. Thus the need for measures of voltage corresponding to measures of power. Data was gathered redundantly and simultaneously. Power data was gathered using a network analyzer 105 while redundant voltage data was gathered using an oscilloscope 109. The graph in FIG. 4 shows a comparison of such data vs frequency.

FIG. 4 illustrates a Comparison of Power to Voltage.

The power curve 401 and the voltage curve 403 may be substantially on top of each other indicating good correlation between measured power gathered with the HP3577A network analyzer 105, and voltage data gathered with the Tektronix 2266A oscilloscope 109.

### Comparison of Transmitted Voltage to Received Voltage

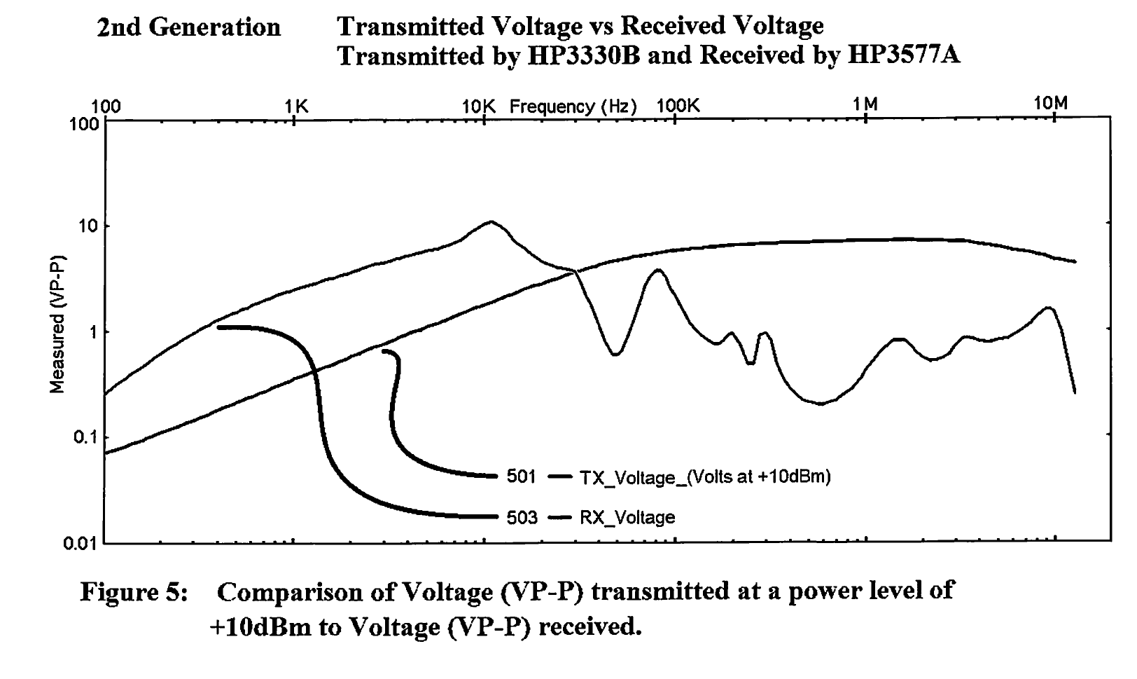

The inductance of the transmit coil 113 and receive coil 123 may be near optimized for voltage gain while targeting the correct frequency range corresponding to well depths ranging from 1000 feet to 30,000 feet. Although the power received by the receiver 105 is always less than power transmitted by the transmitter 103, like a transformer, the voltage received is dependent on factors such as the impedance at that frequency and distance. It may be possible to receive voltages which are greater than their corresponding transmitted voltages. This phenomenon may be desirable since harvesting of electromagnetic power is dependent on both power and voltage. The graph in FIG. 5 below plots the simultaneously measured voltage across the transmit coil 113 and the voltage across the receive coil 121.

FIG. 5 illustrates the Voltage (VP-P) transmitted by the transmitter 103 at a power level of +10 dBm, and voltage (VP-P) received by the receiver 105. The voltage across the receive coil 121 (trace with many peaks) exceeds the voltage across the transmit coil for all frequencies from substantially 100 Hz to 25 KHz. Good power transmission and easy harvesting of power may be accomplished in this frequency band. Power transmission and harvesting of power may be still possible at higher frequencies however, and the insertion loss may be greater and considerations of frequency (distance) may dominant.

### Minimum Power in Order to Harvest

In almost all power harvesting methods, there may be a minimum voltage threshold level (Vmin) below which harvesting is not possible. The value of Vmin may vary from industry to industry, but a practical target may be useful and thus will be calculated here. The most common method of harvesting power is to use a full-wave bridge rectifier constructed using diodes such as Schottky diodes. Schottky diodes may have a relatively low forward voltage of 0.2 Volts. In operation, two diodes may be in series with the output, and thus these two diodes may represent an immediate voltage loss equal to twice the forward voltage loss for a single Schottky diode (i.e. 2*0.2 Volts=0.4 Volts). To this voltage value additional “overhead” they exist in order to turn on any active devices, such as transistors. For an example, enhancement-mode Metal Oxide Semiconductor (MOS) transistors with a threshold voltage of 0.6 Volts may be used. Consequently, the minimum voltage threshold level (Vmin=2*0.2+0.6=1.00 Volts) is equal to 1.00 Volts.

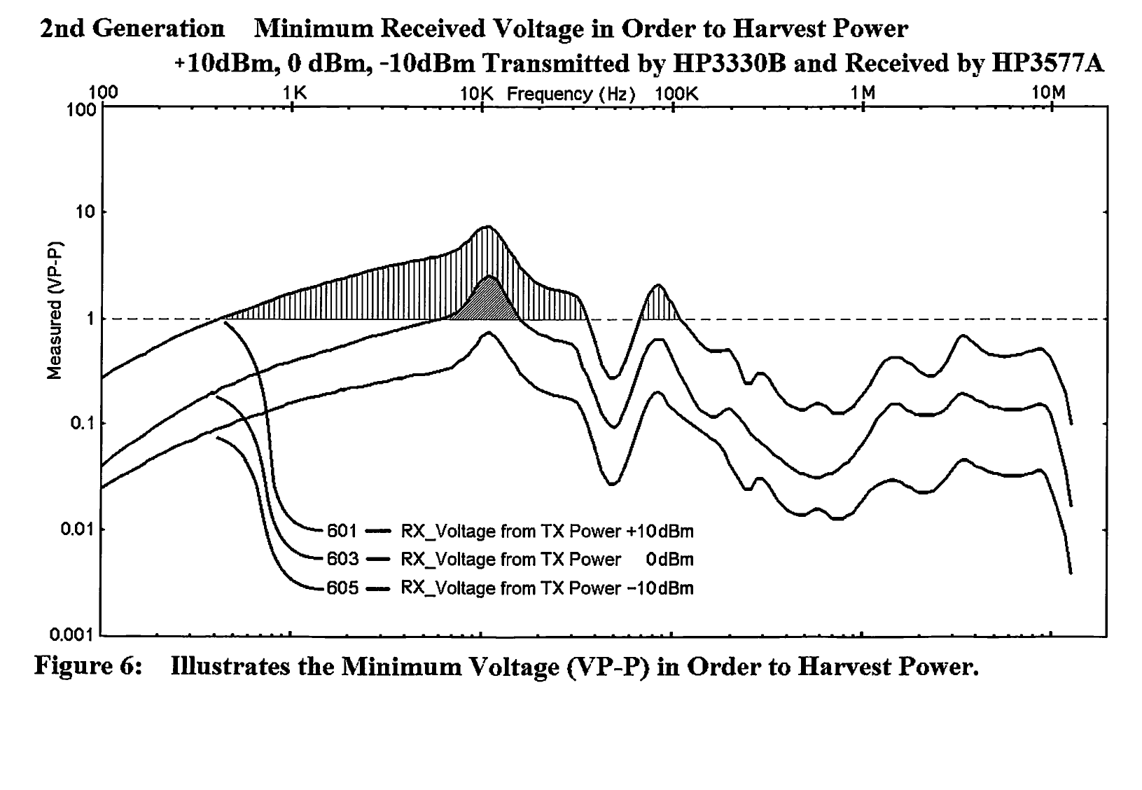

In the graph shown in FIG. 6, three receive voltages in the form of a first curve 601, a second curved 603 and a third curve 605 (measured using a Tektronix model 2246A oscilloscope 109) are illustrated and compared. These are:
Voltage (VP-P) at the receive coil 121 when the transmit coil 113 is driven with +10 dBm as shown in curve 601.
Voltage (VP-P) at the receive coil 121 when the transmit coil 113 is driven with 0 dBm as shown in curve 603.
Voltage (VP-P) at the receive coil when the transmit coil is driven with −10 dBm as shown in curve 605.

Of the three traces representing the received voltages at the receive coil 121, two curves 601 and 602 may have peaks which rise above 1.00 VP-P. The portion of this curve which is above 1.00 VP-P is shown highlighted in shade.

FIG. 6 illustrates Voltage (VP-P) transmitted and received at two power levels (+15 dBm, −10 dBm).

The plot of received power with a corresponding transmit power level of +10 dBm (10 mW) is highlighted in shade and indicates useful power can be harvested at substantially 10 KHz and at substantially 80 KHz. The plot of 0 dBm (1 mW) power level highlighted in shade, indicates useful power can be harvested at 10 KHz. The plot at −10 dBm (100 uW) shows no useful peaks.

### Impedance and Maximum Power Transfer

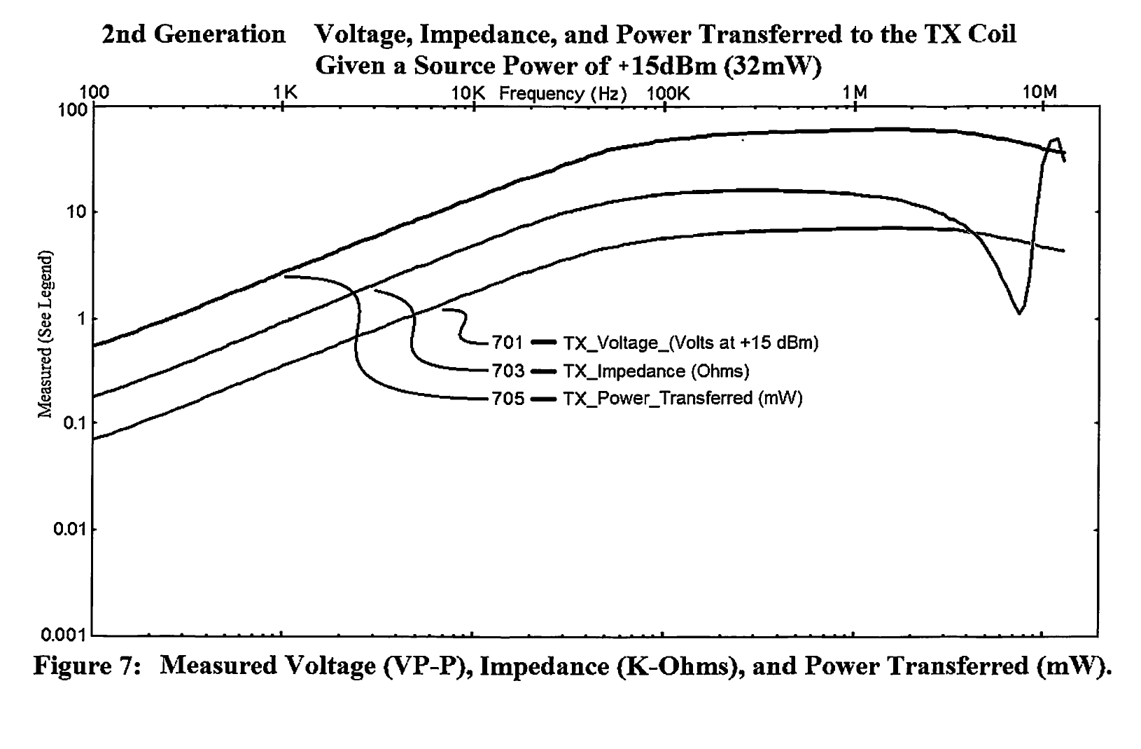

The impedance of both the transmit coil 113 (antenna) and the receive coil 121 (antenna), being predominately inductors may vary with frequency. As frequency increases, the impedance of real-world inductor increases until the parasitic parallel capacitance of the windings cause the impedance to fall again (i.e. self-resonance). This impedance change limits the amount of power that can be transferred between the inductor coil and any real-world electronics. It affects both the transmit side as well as the receive side. Mitigation of this issue is complex and is beyond the scope here however, performance of this power transfer due to impedance change over frequency was measured and plotted in FIG. 7.

FIG. 7 illustrates the Measured Voltage (VP-P), Impedance (K-Ohms), and Power Transferred (mW).

The impedance (curve 701) rises, and may reach a plateau at substantially 100 KHz and then falls at 10 MHz. The power transferred to the transmit coil 113 (curve 705 in the plateau region) may be substantially 10 mW. The power generated by the transmitter (synthesizer) 103 may be +15 dBm (32 mW), indicating a transfer may be 31%. Which may mean that 31% of the power generated by the transmitter (synthesizer) 103 reaches the transmit coil 113. The −3 dB bandwidth (a common measure of power bandwidth) may be from substantially 20 KHz to 20 MHz. The −6 dB bandwidth may be from substantially 10 KHz to 20 MHz.

### CONCLUSION

There are a number or variations of designs and design trade-offs: power transfer from the transmitter 103 to the transmit coil 113, insertion loss along the transmission media for example the wellbore pipe 101, impedance matching, and voltage harvesting. Given this particular application where distance may be an unknown variable, the operating frequency choice may be at substantially 10 KHz. At this frequency, the impedance of the transmit coil 113 may have reached the −6 dB point where substantially 25% of the generated power from the transmitter 103 reaches the transmit coil 113. Then given insertion loss for the distance between the source such as the transmitter 103 and destination such as the receiver 105, the total transfer function can be determined. Then it is just a matter of enough power at the source to provide the desired power at the destination. The power signal may be in the range from a fraction of a milliwatt to multiple kilowatts.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A transmission system for transmitting a power signal, comprising:
a power generator to generate the power signal to the transmitted;
an AC to AC converter to convert a frequency of the power signal;
a transmitter to transmit the power signal including a transformer to convert the voltage of the power signal and a transmit coil to transmit the power signal;
a transmission line to receive the power signal from the transmit coil;
a receiver to receive the power signal from the transmission line;
wherein the transmission line is rotatable and movable in the longitudinal direction of the transmission line.

2. A transmission system for transmitting a power signal as in claim 1, wherein the receiver includes a receive coil to receive the power signal from the transmission line.

3. A transmission system for transmitting a power signal as in claim 1, wherein the transmission line is a pipe.

4. A transmission system for transmitting a power signal as in claim 1, wherein the transmission line is a well bore pipe.

5. A transmission system for transmitting a power signal as in claim 1, wherein the receiver includes a transformer.

6. A transmission system for transmitting a power signal as in claim 1, wherein the receiver includes a AC/AC converter.

7. A transmission system for transmitting a power signal as in claim 1, wherein the receiver includes a AC/DC converter.

8. A transmission system for transmitting a power signal as in claim 1, wherein the power signal is in the range from a fraction of a milliwatt to multiple kilowatts.
